(19) United States
(12) Patent Application Publication
(10) Pub. No.: US 2026/0106197 A1
(43) Pub. Date: Apr. 16, 2026

(54) CYLINDRICAL REDOX FLOW BATTERY

(71) Applicant: JUNG SEOK YI, Seongnam-si (KR)

(72) Inventor: JUNG SEOK YI, Seongnam-si (KR)

(21) Appl. No.: 19/321,016

(22) Filed: Sep. 5, 2025

(30) Foreign Application Priority Data
Oct. 15, 2024 (KR) 10-2024-0139920

(51) Int. Cl. H01M 8/1004; H01M 8/04186; H01M 8/18

(52) U.S. Cl. CPC H01M 8/1004; H01M 8/04186; H01M 8/188

(57) ABSTRACT

In order to prevent the occurrence of shunt current and the reduction in the active area of the separation plate, but enable efficient spatial disposition of a plurality of redox flow batteries by providing a redox flow battery composed of unit cells, the present disclosure provides a cylindrical redox flow battery including: a cylindrical case; a lid which is fastened to an upper end of the case, but includes a first electrolyte outlet so that the first electrolyte can flow out from the first space of the case; and unit cells which are disposed in the case.

### CROSS-REFERENCE TO RELATED APPLICATION

The present application claims priority under 35 U.S.C. § 119(a) to Korean patent application number 10-2024-0139920 filed on Oct. 15, 2024, in the Korean Intellectual Property Office, the entire disclosure of which is incorporated by reference herein.

### TECHNICAL FIELD

The present disclosure relates to a cylindrical redox flow battery.

### BACKGROUND ART

Recently, environmental pollution and global warming have led to increasingly stringent restrictions on the use of fossil fuels including oil. Consequently, various technologies are being developed to increase sustainable energy use and energy efficiency. In particular, technologies for efficient energy management, such as energy management systems, virtual power plants, and microgrids, are attracting attention, and energy storage systems (ESS) are in the core thereof.

An ESS is a system which stores power and supplies power when it is needed, thereby increasing power use efficiency.

Among the various energy storage devices applied to the ESS, large-capacity secondary batteries are expected to be highly promising devices. Since the Redox Flow Battery (RFB) among these has an exceptionally long lifespan of 20,000 cycles and 20 years, and can design output and energy completely independently, it mentioned as the most promising technology in a secondary battery for long-term ESS with output durations of two hours or more.

A redox flow battery is a system in which the electrolyte is stored in a liquid state in an external tank and supplied into the battery via a pump during the charging and discharging process, and the active materials in the electrolyte are charged and discharged by redox reactions, and is an electrochemical storage device which directly stores the chemical energy of the electrolyte as electrical energy. For example, the redox flow battery includes a vanadium redox flow battery (VRFB).

Compared to other batteries, a redox flow battery offers many advantages when used for large-scale energy storage devices. For example, the redox flow battery exhibits low self-discharge, high discharge rate resistance, has no lifespan limitations in its active materials, has very low maintenance costs, operates at room temperature, and has less environmental problems, making it suitable for a large-capacity energy storage device.

In order to increase capacity, existing redox flow batteries form a stack structure by arranging multiple planar unit cells in succession, as shown in FIG. 1A. At this time, an electrolyte having liquid ionic conductivity is supplied/discharged to the battery stack, and since the unit cells are disposed at close intervals, in addition to the path through which charging and discharging occur through electrochemical reactions, ions can move to the surrounding unit cells along the supply/discharge path of the electrolyte to generate a flow of current. This is called shunt current. Accordingly, in order to prevent the decrease in efficiency due to shunt current when forming a stack structure by arranging multiple unit cells in succession in the existing redox flow batteries, a structure which increases the path of the flow path part of the separation plate was introduced as shown in FIG. 1B to prevent the generation of shunt current. However, there are problems in that such a method leads to a decrease in the active area of the separation plate, and the energy density of the redox flow battery is lowed compared to its size.

### DISCLOSURE

### Technical Problem

An object of the present disclosure is to provide a redox flow battery composed of unit cells in order to solve the above problems, thereby preventing the occurrence of shunt current and the reduction in the active area of the separation plate, and providing a cylindrical redox flow battery that enables efficient spatial disposition of a plurality of redox flow batteries.

### Technical Solution

The present disclosure provides a cylindrical redox flow battery including: a cylindrical case having a first partition wall formed in a cylindrical shape on the outer side thereof and a second partition wall formed in a cylindrical shape on the inner side of the first partition wall, including a first space which is defined by the inner side of the first partition wall and the outer side of the second partition wall and has an open upper portion and a second space which is defined by the inner side of the second partition wall and has an open upper portion, and including a second electrolyte inlet which is formed in the lower portion of the first partition wall so that a second electrolyte flows in through the second electrolyte inlet, a second electrolyte outlet which is formed in the upper portion of the first partition wall so that the second electrolyte flows out through the second electrolyte outlet, and second partition through-holes which is formed so that the first electrolyte flowed into the second space can move from the second space to the first space; a lid which is fastened to an upper end of the case, but includes a first electrolyte outlet so that the first electrolyte can flow out from the first space of the case; and unit cells which are disposed in the case, wherein the unit cells are wound in a roll shape and disposed in the first space.

### Advantageous Effects

The cylindrical redox flow battery of the present disclosure can increase capacity while preventing the generation of shunt current and reduction of active area of the separation plate.

The cylindrical redox flow battery of the present disclosure can efficiently dispose a plurality of redox flow batteries within a predetermined space.

### DESCRIPTION OF DRAWINGS

FIGS. 1A and 1B are schematic diagrams of an existing redox flow battery configuration.

FIGS. 2, 3 and 4 are schematic diagrams of cylindrical redox flow batteries according to respective embodiments.

FIGS. 5A and 5B are schematic diagrams of a case and a lid of a cylindrical redox flow battery according to one embodiment.

FIG. 6 is a schematic diagram of a unit cell of a cylindrical redox flow battery according to one embodiment.

FIG. 7 is a schematic diagram of a unit cell viewed from direction A of FIG. 6.

FIG. 8 is a schematic diagram of a unit cell of a cylindrical redox flow battery according to one embodiment.

FIG. 9 is a schematic diagram of a unit cell viewed from direction A of FIG. 8.

FIG. 10 is a schematic diagram of a unit cell viewed from direction B of FIG. 6.

FIG. 11 is a schematic diagram illustrating a cross-section of a unit cell according to one embodiment based on the z-y plane when wound.

FIG. 12 is a schematic diagram illustrating a unit cell distal end according to one embodiment.

FIG. 13 is a schematic diagram illustrating a unit cell wound in a roll shape in the first space of a case according to one embodiment and a unit cell distal end.

FIG. 14 is a schematic diagram illustrating a cylindrical redox flow battery and module according to one embodiment.

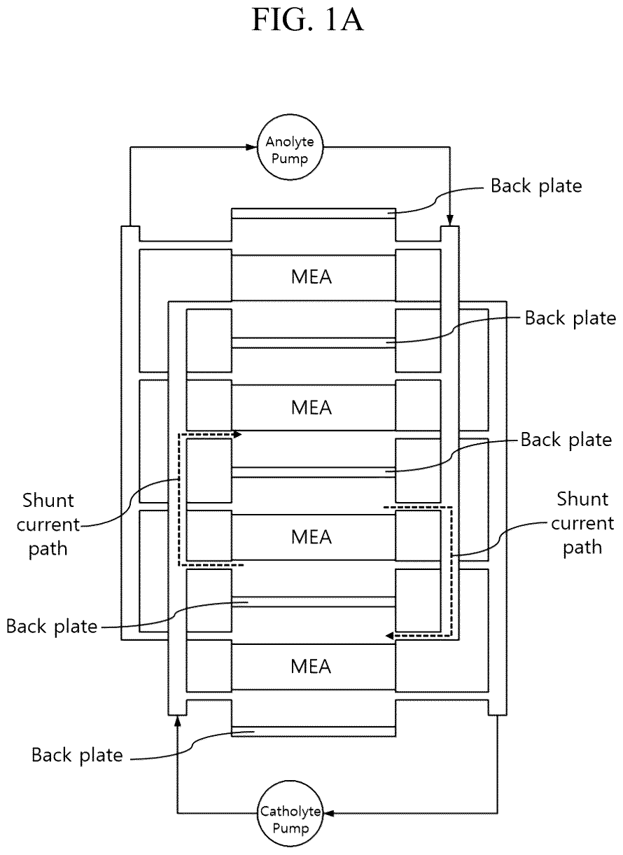

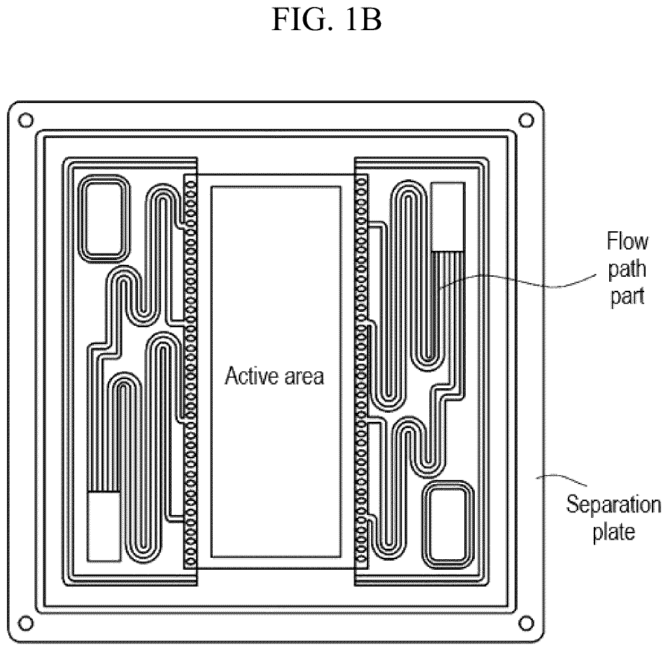

### MODE FOR DISCLOSURE

Hereinafter, embodiments of the present disclosure will be described in detail. However, the present disclosure is not limited to the embodiments disclosed below, but can be implemented in various different forms, and the present embodiments are provided only to make the disclosure of the present disclosure complete and to more completely inform those skilled in the art of the contents of the present disclosure.

Hereinafter, a detailed description will be given with reference to the drawings.

In the drawings, the x-axis direction is defined and described as the length direction, the y-axis direction as the width direction or thickness direction, and the z-axis direction as the up-down direction or height direction. However, this is merely for convenience of explanation, and may be expressed or applied differently depending on the actual design, installation, or disposition.

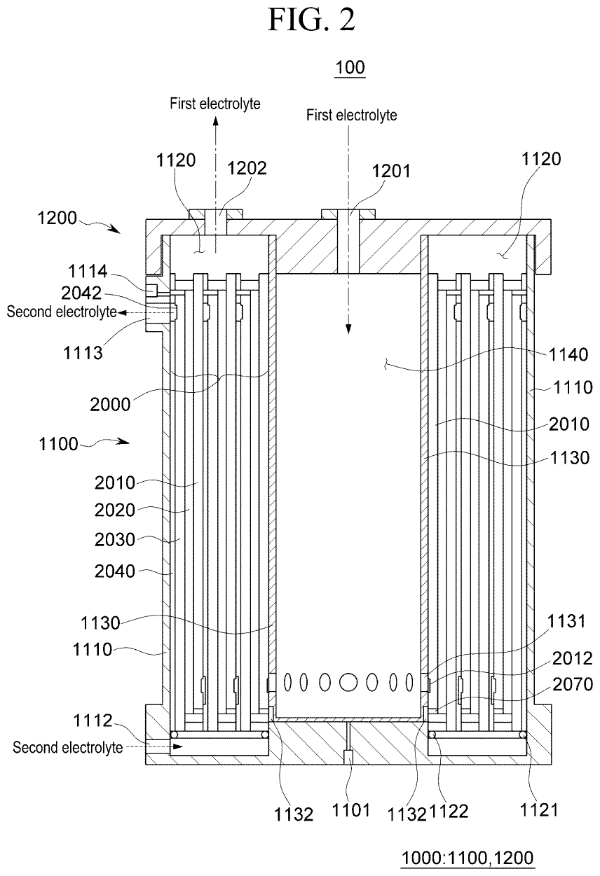

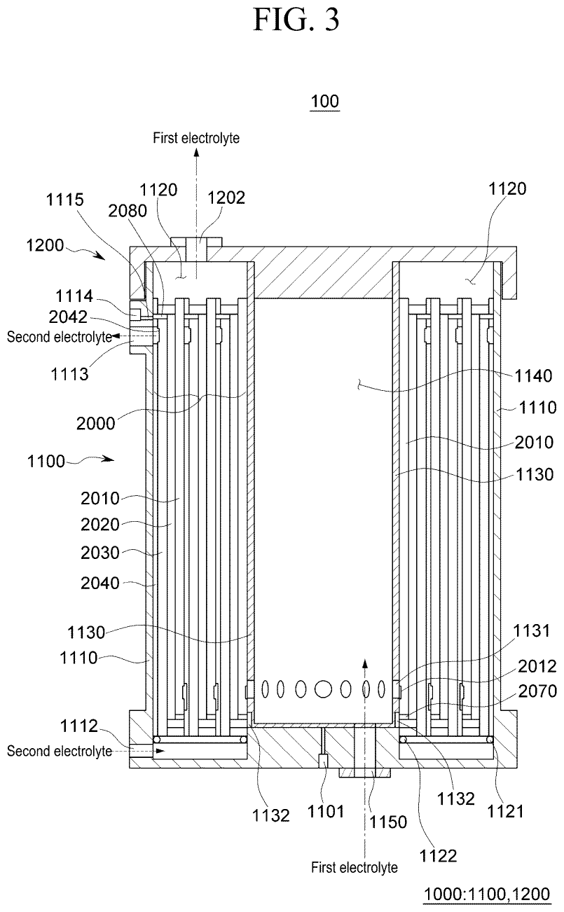

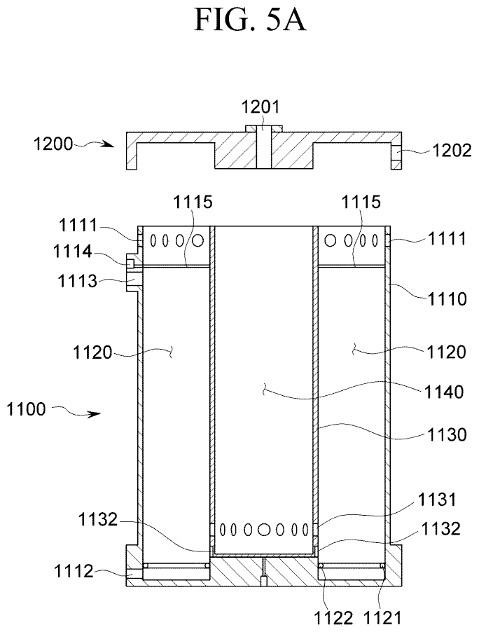

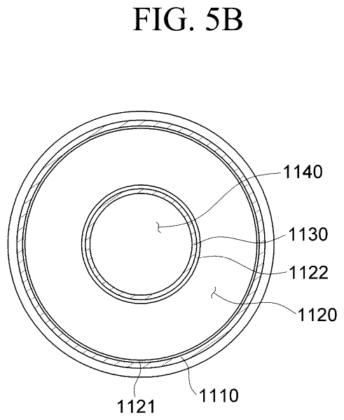

FIGS. 2, 3 and 4 are schematic diagrams of cylindrical redox flow batteries according to respective embodiments, and FIGS. 5A and 5B are schematic diagrams of a case and a lid of a cylindrical redox flow battery according to one embodiment. The following description will be given with reference to FIGS. 2 to 5B.

A cylindrical redox flow battery 100 according to one embodiment includes a housing 1000 including a case 1100 and a lid 1200, and unit cells 2000 disposed inside the case 1100.

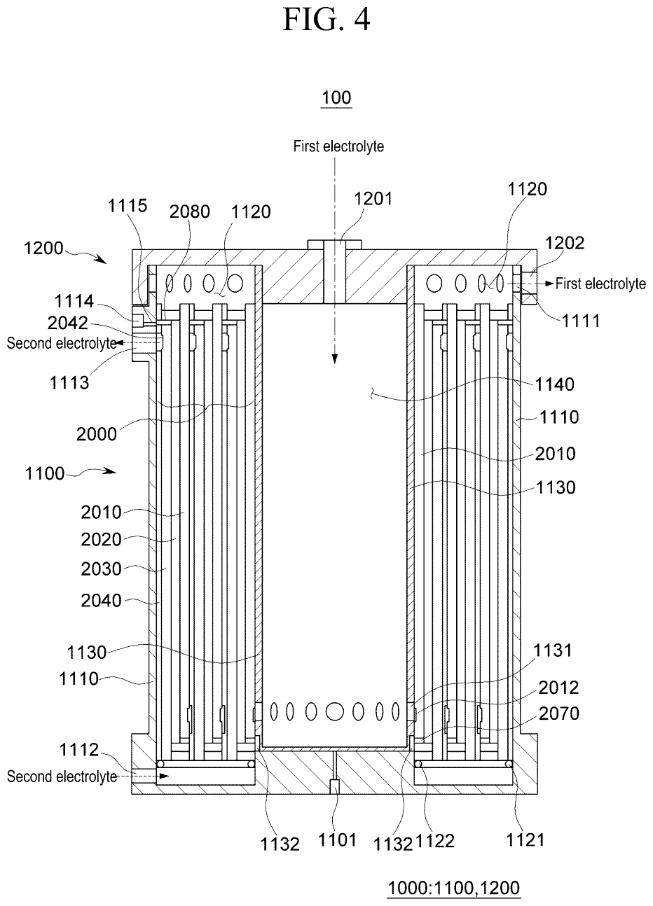

The case 1100 may have a first partition wall 1110 formed in a cylindrical shape on the outer side, and a second partition wall 1130 formed in a cylindrical shape on the inner side of the first partition wall 1110. At this time, the central axis of the cylinder formed by the first partition wall 1110 and the central axis of the cylinder formed by the second partition wall 1130 may be the same. Accordingly, as shown in FIG. 4(B), which is a schematic diagram of the case 1100 viewed from above, the circumference of the first partition wall 1110 and the circumference of the second partition wall 1130 may form concentric circles.

The case 1100 may be formed such that the upper ends of the first partition wall 1110 and the second partition wall 1130 are at the same height.

The case 1100 may include a first space 1120 with an open upper portion defined by the inner side of the first partition wall 1110 and the outer side of the second partition wall 1130, and a second space 1140 with an open upper portion defined by the inner side of the second partition wall 1130.

The case 1100 may be formed such that the lower end of the first space 1120 is lower than the lower end of the second space 1140.

The unit cells 2000 may be disposed in the first space 1120 of the case 1100. For example, the unit cells 2000 may be disposed in the first space 1120 in a form that is wound in a roll shape one or more times. At this time, the unit cells 2000, in a state in which the unit cells 2000 are wound in a roll shape, may be disposed so that the insulating plate 2040 located at the outermost side is in close contact with the inner side of the first partition wall 1110, and may be disposed so that the first separation body 2010 located at the innermost side is in close contact with the outer side of the second partition wall 1130. At this time, non-conductive resins, for example, materials such as ethylene-vinyl acetate (EVA), polyolefins, polyamides, polyesters, styrene block copolymers, polyethylene, ethylene-methyl acrylate (EMA), ethylene n-butyl acrylate (EnBA), PE, PP, PVC, PVDF, acrylonitrile-butadiene rubber (NBR), ethylene-propylene-diene rubber (EPDM), vinyl-methyl silicon rubber (VMQ), fluorosilicon rubber (FVMQ), and fluorocarbon rubber (FKM), may be applied and sealed between the insulating plate 2040 and the first partition wall 1110 and between the first separation body 2010 and the second partition wall 1130, but the present disclosure is not limited thereto. Accordingly, movement of fluid between the insulating plate 2040 and the first partition wall 1110 and between the first separation body 2010 and the second partition wall 1130 may be prevented.

In addition, when the unit cells 2000 are disposed in the first space 1120 in a form wound in a roll shape one or more times, the insulating plate 2040 and the first separation body 2010 may be in contact with each other and sealed. At this time, non-conductive resins, for example, materials such as ethylene-vinyl acetate (EVA), polyolefins, polyamides, polyesters, styrene block copolymers, polyethylene, ethylene-methyl acrylate (EMA), ethylene n-butyl acrylate (EnBA), PE, PP, PVC, PVDF, acrylonitrile-butadiene rubber (NBR), ethylene-propylene-diene rubber (EPDM), vinyl-methyl silicon rubber (VMQ), fluorosilicon rubber (FVMQ), and fluorocarbon rubber (FKM), may be applied and sealed between the insulating plate 2040 and the first separation body 2010, but the present disclosure is not limited thereto. Accordingly, movement of fluid between the insulating plate 2040 and the first separation body 2010 may be prevented.

The case 1100 may be formed such that the inner diameter of the second space 1140 is 5 cm or more. Accordingly, when the unit cells 2000 are wound and disposed in the first space 1120 in a roll shape, the minimum rotation radius is 2.5 cm or more, thereby preventing deformation and damage of the unit cells 2000 due to excessive bending.

In the first space 1120 of the case 1100, a first stopper 1121 may be formed along the circumference of the first partition wall 1110 by protruding from the inner side of the first partition wall 1110 at a position spaced upward from the lower end of the inside of the first space 1120 by a predetermined distance, and a second stopper 1122 may be formed along the circumference of the second partition wall 1130 by protruding from the outer side of the second partition wall 1130. At this time, the first stopper 1121 and the second stopper 1122 may be formed at the same height. Accordingly, when the unit cells 2000 are disposed in the first space 1120 of the case 1100, the lower ends of the unit cells 2000 may be disposed at a certain distance spaced from the lower portion of the first space 1120.

The first partition wall 1110 may include a second electrolyte inlet 1112 through which the second electrolyte flows into the lower portion. For example, the second electrolyte inlet 1112 may be formed lower than the first stopper 1121. Accordingly, the second electrolyte flowed into the second electrolyte inlet 1112 may flow into the second separation body 2030 of the unit cells 2000 from the lower portion of the first space 1120.

The first partition wall 1110 of the case 1100 may include a second electrolyte outlet 1113 through which the second electrolyte flows out at the upper portion. For example, when the unit cells 2000 are disposed in the first space 1120, the second electrolyte outlet 1113 may be formed at a position corresponding to the insulating plate slit 2042. Accordingly, the second electrolyte that has moved along the second separation body 2030 of the unit cells 2000 may be discharged to the outside of the cylindrical redox flow battery 100 through the second electrolyte outlet 1113 when the second electrolyte is discharged through the insulating plate slit 2042 after passing through the second separation body 2030.

The case 1100 may include a first electrolyte lower inlet 1150 into which the first electrolyte flows at the lower portion of the second space 1140.

The second partition wall 1130 of the case 1100 may include a second partition wall through-hole 1131 through which the first electrolyte flowed into the second space 1140 is discharged. For example, when the unit cells 2000 are disposed in the first space 1120, a plurality of second partition wall through-holes 1131 may be formed at positions corresponding to the first separation body groove 2012.

The lid 1200 may be fastened to the upper end of the case 1100, but may include a first electrolyte outlet 1202 so that the first electrolyte may flow out from the first space 1120 of the case 1100. For example, the first electrolyte outlet 1202 may be directly communicated with the upper space of the first space 1120 so that the first electrolyte, which flows into the first separation body 2010 through the first separation body groove 2012 of the unit cells 2000 and then moves along the first separation body 2010 and is discharged to the upper portion of the first separation body 2010, may be discharged to the outside of the cylindrical redox flow battery 100. Also, for example, as shown in FIG. 4, when the first electrolyte outlet 1202 is formed on the side surface of the lid 1200 and the position of the first electrolyte outlet 1202 overlaps with the first partition wall 1110, the case 1100 may communicate with the upper space of the first space 1120 through a plurality of first partition wall through-holes 1111 formed at positions corresponding to the first electrolyte outlet 1202 in the first partition wall 1110.

The lid 1200 may include a first electrolyte inlet 1201 so that the first electrolyte flows into the second space 1140.

The lid 1200 may be sealed to prevent other fluid or gas from flowing into or out of the case 1100 except for the first electrolyte inlet 1201 and the first electrolyte outlet 1202. In addition, the lid 1200 may be sealed to prevent any fluid or gas from moving from the upper portion of the case 1100 to the first space 1120 and the second space 1140.

The case 1100 may include a first electrode grid contact part 1132 on the outer side of the second partition wall 1130. For example, the first electrode grid contact part 1132 may be formed at a position corresponding to the first electrode grid 2070 of the unit cells 2000 when the unit cells 2000 are disposed in the first space 1120. At this time, the first electrode grid contact part 1132 may be electrically connected to the first terminal 1101 exposed on the outer surface of the case 1100.

The case 1100 may include a second electrode grid contact part 1115 on the inner side of the first partition wall 1110. For example, the second electrode grid contact part 1115 may be formed at a position corresponding to the second electrode grid 2080 of the unit cells 2000 when the unit cells 2000 are disposed in the first space 1120. At this time, the second electrode grid contact part 1115 may be electrically connected to the second terminal 1114 exposed on the outer surface of the case 1100.

The case 1100 may have synthetic resins, ceramics, and insulating-coated metals applied thereto, but the present disclosure is not limited thereto.

In this way, when the unit cells 2000 are wound in a roll shape and disposed in the case 1100, a single unit cell 2000 may be applied, but according to the expansion of the area of the unit cell 2000, not only the capacity of the redox flow battery may be increased, but also the space relative to the expanded area may be efficiently utilized. Accordingly, the cylindrical redox flow battery 100 of the present disclosure can easily expand capacity while preventing the generation of shunt current and maximizing the active area in the separation plate, and one or more cylindrical redox flow batteries 100 can be efficiently disposed in a certain space.

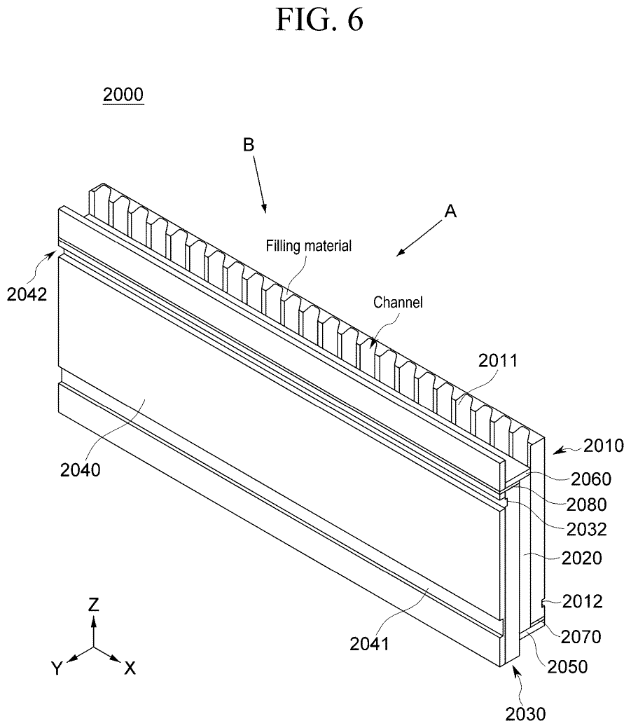

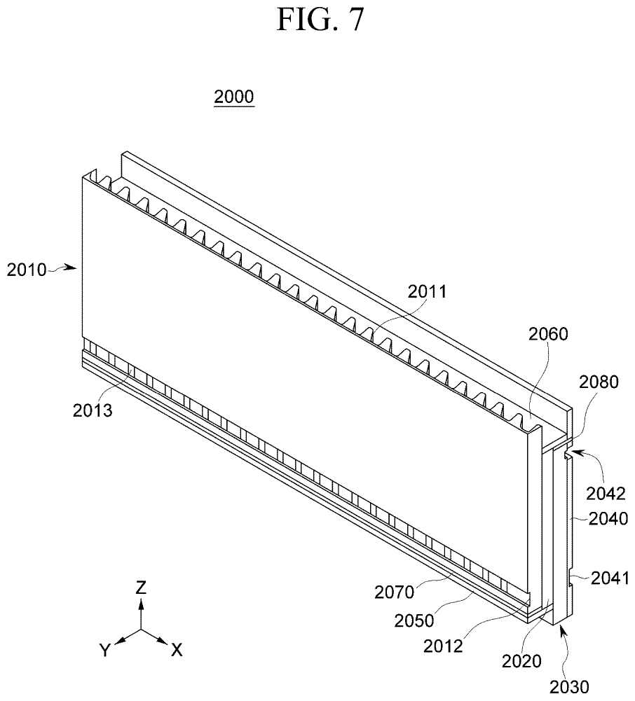

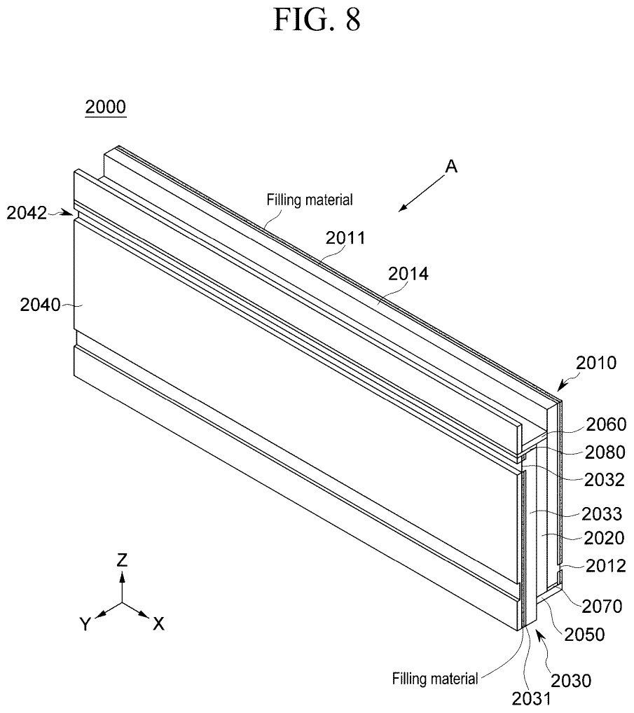

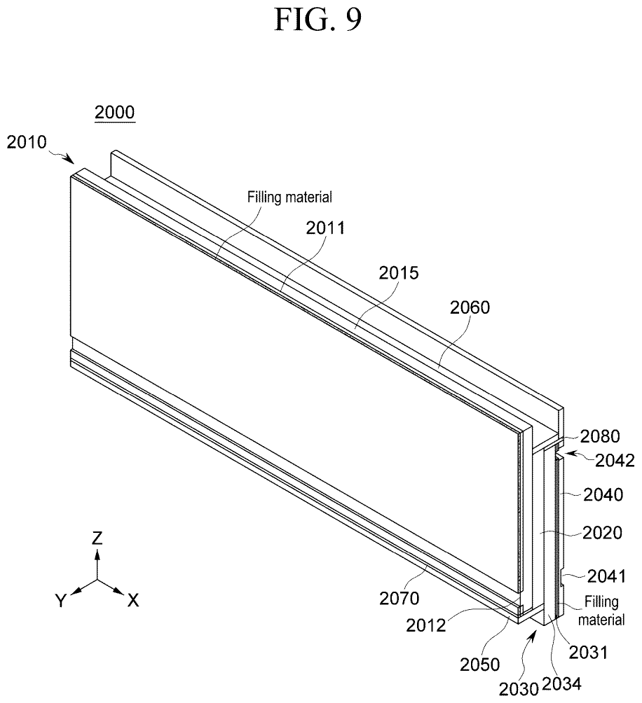

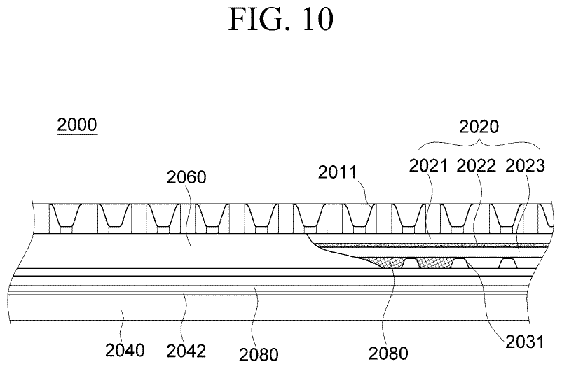

FIG. 6 is a schematic diagram of a unit cell of a cylindrical redox flow battery according to one embodiment, FIG. 7 is a schematic diagram of a unit cell viewed from direction A of FIG. 6, FIG. 8 is a schematic diagram of a unit cell of a cylindrical redox flow battery according to one embodiment, FIG. 9 is a schematic diagram of a unit cell viewed from direction A of FIG. 8, FIG. 10 is a schematic diagram of a unit cell viewed from direction B of FIG. 6. FIGS. 6 to 10 illustrate only some sections of the unit cell extending in the length direction. In addition, FIG. 10 illustrates the schematic diagram as a form in which the second sealant 2060 and the second electrode grid 2080 are partially removed for convenience of understanding and explanation of the unit cell structure.

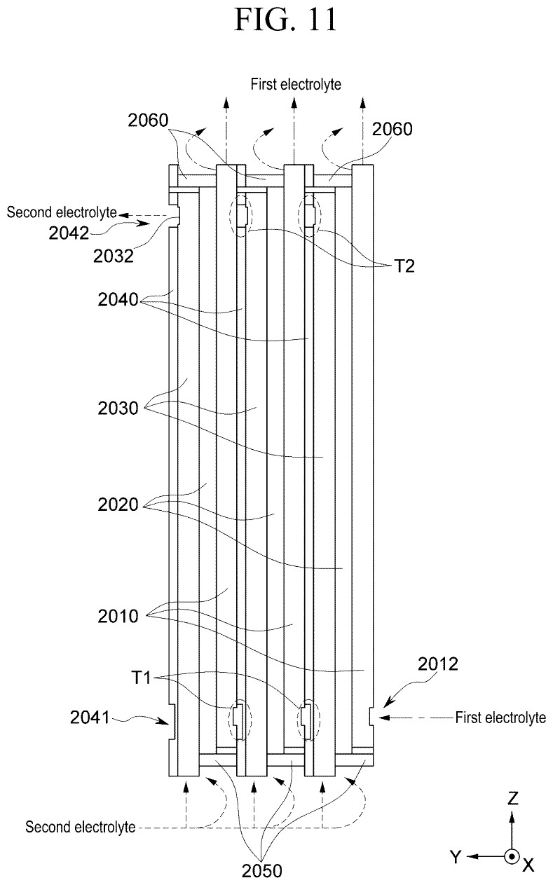

FIG. 11 is a schematic diagram illustrating a cross-section of a unit cell according to one embodiment based on the z-y plane when wound.

The following description will be given with reference to FIGS. 6 to 11.

The unit cells 2000 may include a membrane electrode assembly (MEA) including an electrode and a separator, and a separation body which is in contact with the electrode. At this time, the separation body may include a first separation body 2010 and a second separation body 2030.

The membrane electrode assembly 2020 may be disposed and bonded in the order of a first electrode 2021, a separator 2022, and a second electrode 2023 based on the width direction (y-axis direction). At this time, carbon felt, carbon cloth, and carbon paper may be applied to the first electrode 2021 and the second electrode 2023, but the present disclosure is not limited thereto. In addition, the first electrode 2021 and the second electrode 2023 may include catalysts such as platinum series, nickel series, iron series, chromium series, and copper series, but the present disclosure is not limited thereto. In particular, the first electrode 2021 and the second electrode 2023 to which carbon paper is applied can be stably deformed and maintain their shape stably when the unit cells 2000 are wound and disposed in a roll shape in the first space 1120 and has a minimum rotation radius of 2.5 cm or more.

An ion exchange resin or porous layer separator made of a hydrocarbon-based polymer, a partially fluorine-based polymer, a fluorine-based polymer, for example, Nafion, polyvinylidene fluoride (PVDF), polypropylene (PP), polyethylene (PE), or polytetrafluoroethylene (PTFE) may be applied as the separator 2022, but the present disclosure is not limited thereto.

The first separation body 2010 may include a first separation plate 2011. At this time, a channel through which a first electrolyte moves may be formed on a surface of the first separation plate 2011 facing the first electrode 2021. For example, referring to FIGS. 6 and 7, the first separation plate 2011 may have irregularities formed in the width direction to form the channel. For example, the irregularities of the first separation plate 2011 may be formed in a web shape, a parallel shape, or an interdigitated shape, but the present disclosure is not limited thereto. Accordingly, the first electrolyte may pass through the channel on the surface that is in contact with and bonded to the first electrode 2021 of the membrane electrode assembly 2020, and may participate in oxidation-reduction and electrochemical reactions occurring in the membrane electrode assembly 2020.

In addition, the first separation body 2010 may include a first pore body 2014 through which the first electrolyte moves between the first separation plate 2011 and the first electrode 2021. For example, referring to FIGS. 8 and 9, the first separation plate 2011 may include a first pore body 2014 having a porous mesh or foam-shaped structure. At this time, the first pore body 2014 may be applied with materials such as carbon, graphite, carbon paper, carbon felt, stainless steel, titanium nickel, aluminum, niobium, polypropylene (PP), polyethylene (PE), polyvinyl chloride (PVC), polyvinylidene fluoride (PVDF), and polytetrafluoroethylene (PTFE), but the present disclosure is not limited thereto. Accordingly, the first electrolyte can pass through the pores of the first pore body 2014 between the first electrode 2021 of the membrane electrode assembly 2020 and the first separation plate 2011, and participate in the oxidation-reduction and electrochemical reactions occurring in the membrane electrode assembly 2020.

A filling material may be applied to the surface opposite to the surface of the first separation body 2010 facing the first electrode 2021.

The second separation body 2030 may include a second separation plate 2031. At this time, the second separation plate 2031 may have a channel formed on a surface facing the second electrode 2023, through which the second electrolyte moves. For example, the second separation plate 2031 may have irregularities formed in the width direction to form the channel. For example, the irregularities of the second separation plate 2031 may be formed in a web shape, a parallel shape, or an interdigitated shape, but the present disclosure is not limited thereto. Accordingly, the second electrolyte may pass through the channel on the surface that is in contact with and bonded to the second electrode 2021 of the membrane electrode assembly 2020, and participate in oxidation-reduction and electrochemical reactions occurring in the membrane electrode assembly 2020.

In addition, the second separation body 2030 may include a second pore body 2033 through which the second electrolyte moves between the second separation plate 2031 and the second electrode 2023. For example, the second separation plate 2031 may include a second pore body 2033 having a porous mesh or foam-shaped structure. At this time, the second pore body 2033 may be applied with materials such as carbon, graphite, carbon paper, carbon felt, stainless steel, titanium nickel, aluminum, niobium, polypropylene (PP), polyethylene (PE), polyvinyl chloride (PVC), polyvinylidene fluoride (PVDF), and polytetrafluoroethylene (PTFE), but the present disclosure is not limited thereto. Accordingly, the second electrolyte can pass through the pores of the second pore body 2033 between the second electrode 2021 of the membrane electrode assembly 2020 and the second separation plate 2031, and participate in the oxidation-reduction and electrochemical reactions occurring in the membrane electrode assembly 2020.

A filling material may be applied to the surface opposite to the surface of the second separation body 2030 facing the second electrode 2023.

The first separation body 2010 and the second separation body 2030 may also be applied with a material that can be easily deformed when the unit cells 2000 are deformed into a roll shape, and may be processed. For example, the first separation plate 2011 and the second separation plate 2031 may be applied with a carbon composite material or a Grafoil sheet, but the present disclosure is not limited thereto. For example, when the first separation plate 2011 and the second separation plate 2031 applied with a Grafoil sheet that is advantageous for bending deformation can be stably deformed and stably maintain their shapes if the minimum rotation radius on is 2.5 cm or more when the unit cells 2000 are wound in a roll shape and disposed in the first space 1120. In addition, for example, the first separation plate 2011 and the second separation plate 2031 may be applied with polypropylene (PP), polyethylene (PE), polyvinyl chloride (PVC), polyvinylidene fluoride (PVDF), and polytetrafluoroethylene (PTFE), but the present disclosure is not limited thereto.

The first separation plate 2011 may further include a conductor on the opposite surface of the surface facing the first electrode 2021, and the second separation plate 2031 may further include a conductor on the opposite surface of the surface facing the second electrode 2023. For example, the conductor may be an aluminum sheet coated with CNT, graphene, carbon paper, carbon felt, Grafoil, titanium, carbon coated titanium, niobium, aluminum, graphite or graphene, and a grafoil sheet coated with graphite or graphene, but the present disclosure is not limited thereto. At this time, since the conductor does not directly contact the electrolyte, a metal conductor may be used. Accordingly, the electrical conductivity of the first separation body 2010 and the second separation body 2030 may be improved, thereby improving the electrical performance of the unit cells 2000. In addition, when a non-conductive first separation plate 2011 and second separation plate 2031 are applied to the first separation body 2010 and the second separation body 2030, electrical conductivity can be imparted, thereby improving the electrical performance of the unit cells 2000.

The unit cells 2000 may further include an insulating plate 2040, a first sealant 2050, and a second sealant 2060.

The insulating plate 2040 may be bonded to the surface opposite to the surface of the second separation body 2030 that contacts the second electrode 2023. The insulating plate 2040 can serve to separate the first separation body 2010 and the second separation body 2030 so that they are not in direct contact when the unit cells 2000 are wound in a roll shape and disposed in the first space 1120.

The insulating plate 2040 may be applied with chemically stable materials that have flexibility and elasticity, are non-conductive, and do not react with the first electrolyte and second electrolyte. For example, materials such as ethylene-vinyl acetate (EVA), polyolefins, polyamides, polyesters, styrene block copolymers, polyethylene, ethylene-methyl acrylate (EMA), ethylene n-butyl acrylate (EnBA), PE, PP, PVC, PVDF, acrylonitrile-butadiene rubber (NBR), ethylene-propylene-diene rubber (EPDM), vinyl-methyl silicon rubber (VMQ), fluorosilicon rubber (FVMQ), and fluorocarbon rubber (FKM) may be applied, but the present disclosure is not limited thereto.

The filling material may be applied with chemically stable materials that have flexibility and elasticity, are non-conductive, and do not react with the first electrolyte and second electrolyte. For example, materials such as ethylene-vinyl acetate (EVA), polyolefins, polyamides, polyesters, styrene block copolymers, polyethylene, ethylene-methyl acrylate (EMA), ethylene n-butyl acrylate (EnBA), PE, PP, PVC, PVDF, acrylonitrile-butadiene rubber (NBR), ethylene-propylene-diene rubber (EPDM), vinyl-methyl silicon rubber (VMQ), fluorosilicon rubber (FVMQ), and fluorocarbon rubber (FKM) may be applied, but the present disclosure is not limited thereto.

The membrane electrode assembly 2020 may include a first sealant 2050 that seals the lower ends of the first separation body 2010 and the membrane electrode assembly 2020. Accordingly, the first sealant 2050 may prevent the second electrolyte (represented by a dotted arrow) from flowing into the first separation body 2010 and the membrane electrode assembly 2020 but only into the lower portion of the second separation body 2030, as shown in FIG. 11, and may seal the first electrolyte flowed into the first separation body 2010 so that it does not flow out from the lower end of the first separation body 2010. In addition, the membrane electrode assembly 2020 may include a second sealant 2060 that seals the upper ends of the second separation body 2030 and the membrane electrode assembly 2020. Accordingly, the second sealant 2060 may seal the first electrolyte (represented by a single-dot chain arrow) flowed out to the upper portion of the first separation body 2010 as shown in FIG. 11 so that it does not flow into the second separation body 2030 and the membrane electrode assembly 2020, and may seal the second electrolyte flowed into the second separation body 2030 so that it does not flow out to the upper end of the second separation body 2030. Accordingly, the first electrolyte flowing into the unit cells 2000 can only move through the first separation body 2010, and the second electrolyte can only move through the second separation body 2030.

The first sealant 2050 and the second sealant 2060 may be applied with chemically stable materials that have flexibility and elasticity, are non-conductive, and do not react with the first electrolyte and second electrolyte. For example, materials such as ethylene-vinyl acetate (EVA), polyolefins, polyamides, polyesters, styrene block copolymers, polyethylene, ethylene-methyl acrylate (EMA), ethylene n-butyl acrylate (EnBA), PE, PP, PVC, PVDF, acrylonitrile-butadiene rubber (NBR), ethylene-propylene-diene rubber (EPDM), vinyl-methyl silicon rubber (VMQ), fluorosilicon rubber (FVMQ), and fluorocarbon rubber (FKM) may be applied, but the present disclosure is not limited thereto.

The unit cells 2000 may have the upper end of the first separation body 2010 positioned higher than the upper end of the second sealant 2060. Accordingly, when the first electrolyte flows out to the upper portion of the first separation body 2010 as shown in FIG. 11, the first electrolyte may easily flow out through the first separation plate channel surface of the first separation plate 2011 positioned above the upper end of the first separation plate 2011 and the second sealant 2060.

The unit cells 2000 may have the lower end of the second separation body 2030 positioned lower than the lower end of the first sealant 2050. Accordingly, when the second electrolyte flows into the lower portion of the second separation body 2030 as shown in FIG. 11, the second electrolyte may easily flow thereinto through the second separation plate channel surface of the second separation body 2030, which is positioned lower than the lower end of the second separation body 2030 and the first sealant 2050.

The unit cells 2000 may have the upper end of the insulating plate 2040 positioned higher than the upper end of the second sealant 2060, but at the same height as the upper end of the first separation body 2010. Accordingly, the insulating plate 2040 may be in full contact with the first separation body 2010 by corresponding to the first separation body 2010 when the unit cells 2000 are rolled into a roll shape.

The unit cells 2000 may include a first electrode grid 2070 positioned between the lower end of the first separation body 2010 and the first sealing material 2050, and electrically connected to the first electrode 2021 and the first separation plate 2011. At this time, the first electrode grid 2070 may be exposed to the outer side of the first separation body 2010 on the surface opposite to the surface of the unit cells 2000 that faces the membrane electrode assembly 2020. Accordingly, the first electrode grid 2070 may be electrically connected to the first electrode grid contact part 1132 of the case 1100 described above.

The unit cells 2000 may include a second electrode grid 2080 which is positioned between the upper end of the second separation body 2030 and the second sealant 2060, but is electrically connected to the second electrode 2023 and the second separation plate 2031. At this time, the second electrode grid 2080 may be exposed to the outer side of the insulating plate 2040 on the surface opposite to the surface of the unit cells 2000 facing the membrane electrode assembly 2020. Accordingly, the second electrode grid 2080 may be electrically connected to the second electrode grid contact part 1115 of the case 1100 described above.

The first electrode grid 2070 and the second electrode grid 2080 may be formed in the form of a fabric or mesh net so that the first electrode grid 2070 and the second electrode grid 2080 are easily deformed when the unit cells 2000 are deformed into a roll shape, but the present disclosure is not limited thereto.

In addition, the first electrode grid 2070 and the second electrode grid 2080 may be applied with graphite, graphite composites, Grafoil, titanium, aluminum, niobium, and the like, but the present disclosure is not limited thereto.

The ohmic resistance of the unit cells 2000 may increase as the distance between the first electrode grid 2070 and the second electrode grid 2080 increases. Accordingly, the distance between the first electrode grid 2070 and the second electrode grid 2080 may be formed to not exceed 15 cm, but the present disclosure is not limited thereto.

The first separation body 2010 may include a first separation body groove 2012 in which a first separation plate through-hole 2013 passing through from a surface where the filling material is applied to a surface where a channel is formed is formed, or in which the filling material and the first separation plate 2011 are removed and recessed to a predetermined height and width direction so that the first pore body 2014 is exposed and which is formed by being extended in the length direction.

The insulating plate 2040 may include an insulating plate groove 2041 formed by removing and recessing the insulating plate 2040 to a predetermined height and width direction at a position corresponding to the first separation body groove 2012. Accordingly, as shown in FIG. 11, when the unit cells 2000 are wound in a roll shape and disposed in the first space 1120 so that the insulating plate 2040 and the first separation body 2010 come into contact, a first space T1 through which the first electrolyte may flow may be formed by the insulating plate groove 2041 and the first separation body groove 2012. Accordingly, when the first electrolyte flows into the first separation plate through-hole 2013 of the first separation body groove 2012 or the first pore body 2014 through the second partition wall through-hole (FIGS. 2, 1131), the first electrolyte may be evenly spread by moving through the first space T1 between the portion of the first separation body 2010 that is in contact with the second partition wall (FIGS. 2, 1130) and the portion of the first separation body 2010 that is disposed far from the second partition wall (FIG. 2, 1130).

The second separation body 2030 may include a second separation body groove 2032 in which a second separation plate through-hole (not shown) passing through from a surface where the filling material is applied to a surface where a channel is formed is formed, or in which the filling material and second separation plate 2031 are removed and recessed to a predetermined height and width direction so that the second pore body 2033 is exposed and which is formed by being extended in the length direction. In addition, the insulating plate 2040 may include an insulating plate slit 2042 formed by being penetrated so that the second separation body groove 2032 is exposed at a position corresponding to the second separation body groove 2032. Accordingly, as shown in FIG. 11, when the unit cells 2000 are wound in a roll shape and disposed in the first space 1120 so that the insulating plate 2040 and the first separation body 2010 come into contact, a second space T2 through which the second electrolyte can flow may be formed by the second separation body groove 2032 and the insulating plate slit 2042. Accordingly, the second electrolyte flowing out through the second separation plate through-hole (not shown) or the second pore body 2033 of the second separation body 2030 may move along the second space T2 and be easily discharged through the second electrolyte outlet (FIGS. 2, 1113) of the first partition wall (FIGS. 2, 1110).

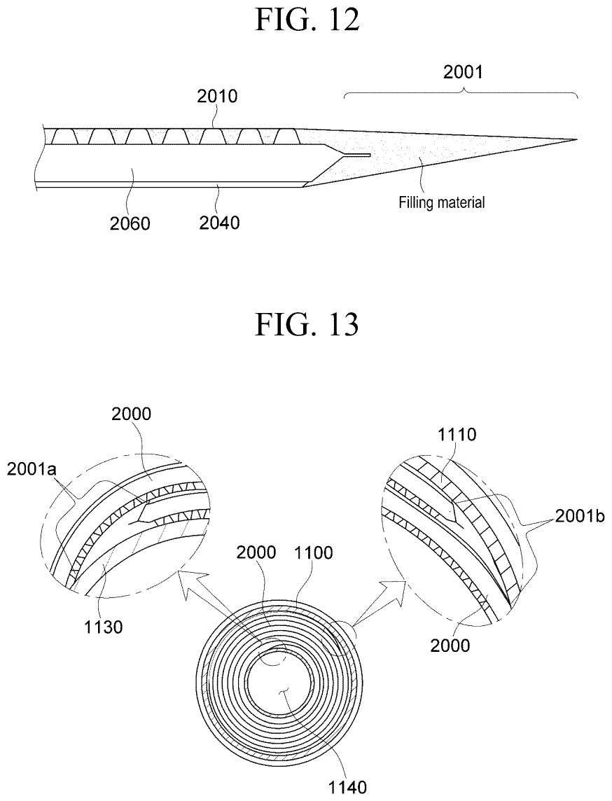

FIG. 12 is a schematic diagram illustrating a unit cell distal end according to one embodiment, and FIG. 13 is a schematic diagram illustrating a unit cell wound in a roll shape in the first space of a case according to one embodiment and a unit cell distal end. The following description will be made with reference to FIGS. 12 and 13.

The unit cells 2000 may have unit cell ends 2001, 2001a and 2001b formed with a filling material. For example, the unit cells 2000 may be formed in a wedge shape with a width that becomes narrower toward the end. For example, when the unit cells 2000 are wound in a roll shape and disposed in the first space 1120 as shown in FIG. 10, the gap between the unit cells 2000 and the second partition wall 1130 may be sealed by inserting the unit cell end 2001a. In addition, when the unit cells 2000 are wound in a roll shape and disposed in the first space 1120 as shown in FIG. 13, the gap between the unit cells 2000 and the first partition wall 1110 may be sealed by inserting the unit cell end 2001b. Accordingly, when the unit cells 2000 are disposed in the first space 1120 of the case (FIGS. 2, 1100), the case (FIGS. 2, 1100) may be sealed by the unit cells 2000 to prevent fluid from moving from the lower portion to the upper portion or from the upper portion to the lower portion. Accordingly, the first electrolyte may move only through the first separation plate (FIGS. 2, 2010), and the second electrolyte may move only through the second separation plate (FIGS. 2, 2030).

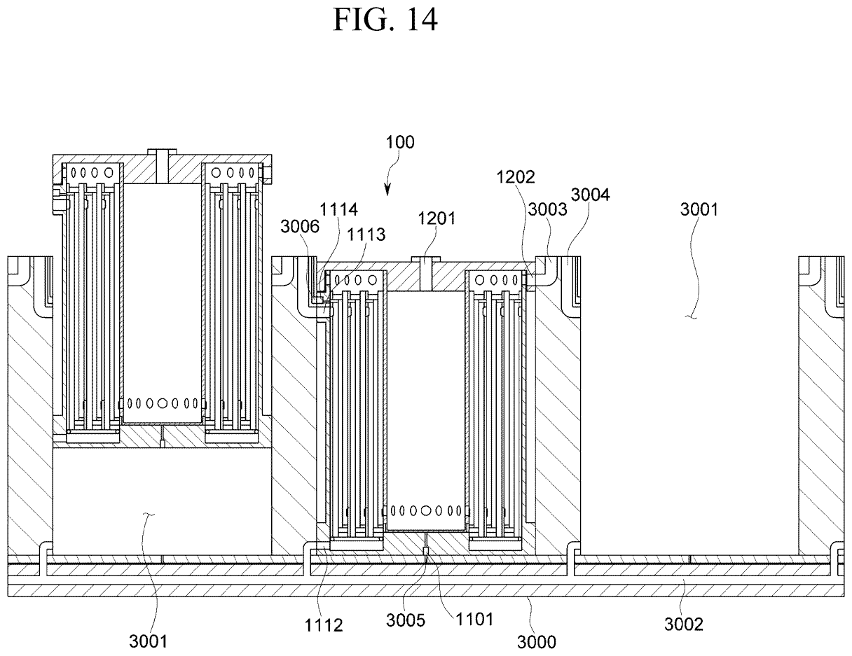

FIG. 14 is a schematic diagram illustrating a cylindrical redox flow battery and module according to one embodiment.

A plurality of the cylindrical redox flow batteries 100 according to the present disclosure can be disposed in various manners and can be electrically connected in series or parallel. In addition, a plurality of the cylindrical redox flow batteries 100 according to the present disclosure can be disposed in various manners and can be connected in various ways for supplying the electrolyte. Accordingly, the cylindrical redox flow batteries 100 can be effectively disposed, safely operated, and the storage capacity can be easily expanded using the cylindrical redox flow batteries 100. For example, as shown in FIG. 14, a module 3000 capable of accommodating the cylindrical redox flow battery 100 may be configured so as to effectively dispose the cylindrical redox flow battery 100 according to the present disclosure and increase its capacity. Specifically, the module 3000 may include a battery accommodation part 3001 into which the cylindrical redox flow battery 100 may be inserted. In addition, for example, the module 3000 may include a first terminal contact part 3005 in electrical contact with a first terminal 1101 of a cylindrical redox flow battery 100 and a second terminal contact part 3006 in electrical contact with a second terminal 1114. In addition, for example, the module 3000 may include a second electrolyte supply pipe 3002 connected to the second electrolyte inlet 1112 of the cylindrical redox flow battery 100 to supply the second electrolyte, a second electrolyte discharge pipe 3004 connected to the second electrolyte outlet 1113 of the cylindrical redox flow battery 100 to discharge the second electrolyte, and a first electrolyte discharge pipe 3003 connected to the first electrolyte outlet 1202 of the cylindrical redox flow battery 100 to discharge the second electrolyte. In addition, although not shown in this drawing, the module 3000 may further include a cover that can cover the upper portion of the module 3000 in which the cylindrical redox flow battery 100 is accommodated. At this time, the cover may include a configuration capable of supplying the first electrolyte or discharging the first electrolyte and the second electrolyte, and may include a configuration capable of being electrically connected to the second terminal contact part 3006, but the present disclosure is not limited thereto. Accordingly, the cylindrical redox flow battery 100 can be effectively disposed and safely operated, and the storage capacity can be easily expanded using the cylindrical redox flow battery 100.

Although, as described above, the embodiments have been described with limited drawings, those skilled in the art can make various modifications and variations possible from the above description. For example, even if the described structures, and other components such as devices, etc. are united or combined in forms different from those of methods described, or replaced or substituted with other components or equivalents, appropriate results can still be achieved.

The drawings schematically illustrate each component as the subject to aid understanding, and the thickness, length, number, etc. of each component depicted may differ from the actual drawing depending on the progress of the drawing making. In addition, the material, shape, and dimensions of each component illustrated in the above embodiments are merely one examples and are not particularly limited, and various modifications are possible within a range that is not substantially departing from the effectiveness of the present disclosure.

Although exemplary embodiments of the present disclosure have been described in detail above, the scope of rights of the present disclosure is not limited thereto, and various modifications and improved forms made by those skilled in the art utilizing the basic concepts of the present disclosure defined in the following claims also fall within the scope of rights of the present disclosure.

### DESCRIPTION OF REFERENCE NUMERALS

100: Cylindrical redox flow battery
1000: Housing
1100: Lower case
1101: First terminal
1110: First partition wall
1111: First partition wall through-hole
1112: Second electrolyte inlet
1113: Second electrolyte outlet
1114: Second terminal
1115: Second electrode grid contact part
1120: First space
1121: First stopper
1122: Second stopper
1130: Second partition wall
1131: Second partition wall through-hole
1132: First electrode grid contact part
1140: Second space
1150: First electrolyte lower inlet
1200: Lid
1201: First electrolyte inlet
1202: First electrolyte outlet
2000: Unit cell
2001, 2001a, 2001b: Unit cell ends
2010: First separation body
2011: First separation plate
2012: First separation body groove
2013: First separation plate through-hole
2014: First pore body
2020: Membrane electrode assembly
2021: First electrode
2022: Separator
2023: Second electrode
2030: Second separation body
2031: Second separation plate
2032: Second separation body groove
2033: Second pore body
2040: Insulating plate
2041: Insulating plate groove
2042: Insulating plate slit
2050: First sealant
2060: Second sealant
2070: First electrode grid
2080: Second electrode grid
3000: Module
3001: Battery accommodation part
3002: Second electrolyte supply pipe
3003: First electrolyte discharge pipe
3004: Second electrolyte discharge pipe
3005: First terminal contact part
3006: Second terminal contact part

1. A cylindrical redox flow battery comprising:
a cylindrical case having a first partition wall formed in a cylindrical shape on the outer side thereof and a second partition wall formed in a cylindrical shape on the inner side of the first partition wall, including a first space which is defined by the inner side of the first partition wall and the outer side of the second partition wall and has an open upper portion and a second space which is defined by the inner side of the second partition wall and has an open upper portion, and including a second electrolyte inlet which is formed in the lower portion of the first partition wall so that a second electrolyte flows in through the second electrolyte inlet, a second electrolyte outlet which is formed in the upper portion of the first partition wall so that the second electrolyte flows out through the second electrolyte outlet, and second partition through-holes which is formed so that the first electrolyte flowed into the second space can move from the second space to the first space;
a lid which is fastened to an upper end of the case, but includes a first electrolyte outlet so that the first electrolyte can flow out from the first space of the case; and
unit cells which are disposed in the case,
wherein the unit cells are wound in a roll shape and disposed in the first space.

2. The cylindrical redox flow battery of claim 1,
wherein the unit cells comprise:
a membrane electrode assembly comprising an electrode and a separator; and
a separation body which is in contact with the electrode.

3. The cylindrical redox flow battery of claim 2,
wherein the electrode includes a first electrode and a second electrode,
the separation body includes a first separation body and a second separation body,
the first separation body is in contact with and bonded to the first electrode,
and the second separation body is in contact with and bonded to the second electrode.

4. The cylindrical redox flow battery of claim 3, comprising:
an insulating plate which is bonded to the surface opposite to the surface of the second separation body that contacts the second electrode;
a first sealant sealing the lower ends of the first separation body and the membrane electrode assembly; and
a second sealant sealing the upper ends of the second separation body and the membrane electrode assembly.

5. The cylindrical redox flow battery of claim 4, wherein the first separation plate includes a conductor on the opposite surface of the surface facing the first electrode, and the second separation plate includes a conductor on the opposite surface of the surface facing the second electrode.

6. The cylindrical redox flow battery of claim 4,
wherein the upper end of the first separation body is positioned higher than the upper end of the second sealant,
the upper end of the insulating plate is positioned higher than the upper end of the second sealant, but at the same height as the upper end of the first separation body, and
the lower end of the second separation body is positioned lower than the lower end of the first sealant.

7. The cylindrical redox flow battery of claim 4, wherein the first separation body includes a first separation plate, a channel through which the first electrolyte moves is formed on a surface facing the first electrode based on the first separation plate, and a filling material is applied to a surface opposite to the surface facing the first electrode,
and the second separation body includes a second separation plate, a channel through which the second electrolyte moves is formed on a surface facing the second electrode based on the second separation plate, and a filling material is applied to a surface opposite to the surface facing the second electrode.

8. The cylindrical redox flow battery of claim 7, wherein the first separation body includes a first separation body groove in which the filling material and the first separation plate are removed and recessed to a predetermined height and width direction so that a first separation plate through-hole passing through from a surface where the filling material is applied to a surface where the channel is formed is formed, and which is formed by being extended in the length direction, the insulating plate includes an insulating plate groove formed by removing and recessing the insulating plate to a predetermined height and width direction at a position corresponding to the first separation body groove, the second separation body includes a second separation body groove in which the filling material and the second separation plate are removed and recessed to a predetermined height and width direction so that a second separation plate through-hole passing through from a surface where the filling material is applied to a surface where the channel is formed is formed, and which is formed by being extended in the length direction, the insulating plate includes an insulating plate slit formed by being penetrated so that the second separation body groove is exposed at a position corresponding to the second separation body groove, and the case is wound and disposed in a roll shape so that the insulating plate of the unit cells faces the first partition wall in the first space, but the second electrolyte outlet is formed at a position corresponding to the position of the insulating plate slit and includes the second partition wall through-hole at a position corresponding to the first separation body groove.

9. The cylindrical redox flow battery of claim 4, wherein the first separation body includes a first separation plate, and includes a first pore body through which the first electrolyte moves between the first separation plate and the first electrode, and a filling material is applied to the surface opposite to the surface of the first separation plate facing the first electrode, and
the second separation body includes a second separation plate, and includes a second pore body through which the second electrolyte moves between the second separation plate and the second electrode, and a filling material is applied to the surface opposite to the surface of the second separation plate facing the second electrode.

10. The cylindrical redox flow battery of claim 9, wherein the first separation body includes a first separation body groove in which the filling material and the first separation plate are removed and recessed to a predetermined height and width direction so that the first pore body is exposed from a surface where the filling material is applied, and which is formed by being extended in the length direction, the insulating plate includes an insulating plate groove formed by removing and recessing the insulating plate to a predetermined height and width direction at a position corresponding to the first separation body groove, the second separation body includes a second separation body groove in which the filling material and the second separation plate are removed and recessed to a predetermined height and width direction so that the second pore body is exposed from a surface where the filling material is applied, and which is formed by being extended in the length direction, the insulating plate includes an insulating plate slit formed by being penetrated so that the second separation body groove is exposed at a position corresponding to the second separation body groove, and the case is wound and disposed in a roll shape so that the insulating plate of the unit cells faces the first partition wall in the first space, but the second electrolyte outlet is formed at a position corresponding to the position of the insulating plate slit and includes the second partition wall through-hole at a position corresponding to the first separation body groove.

11. The cylindrical redox flow battery of claim 4, wherein the insulating plate and the first separation body of the unit cells are wound and disposed in a roll shape so that the insulating plate and the first separation body come into contact and are in close contact with each other, but the unit cells have the insulating plate located at the outermost side in a state in which the insulating plate is wound in a roll shape is disposed to be in close contact with the inner side of the first partition wall, and the first separation body located at the innermost side is disposed to be in close contact with the outer side of the second partition wall.

12. The cylindrical redox flow battery of claim 1, wherein the case is formed to an inner diameter of the second space of 5 cm or more so that when the unit cells are wound and disposed in the first space in a roll shape, the minimum rotation radius is 2.5 cm or more.
